(19) United States
(12) Patent Application Publication
(10) Pub. No.: US 2026/0204166 A1
(43) Pub. Date: Jul. 16, 2026

(54) SYSTEMS AND METHODS FOR MACHINE LEARNING-ENHANCED AIRCRAFT LANDING SCHEDULING UNDER UNCERTAINTIES

(71) Applicants: Yongming Liu, Chandler, AZ (US); Yutian Pang, Milpitas, CA (US); Jueming Hu, Milpitas, CA (US)

(72) Inventors: Yongming Liu, Chandler, AZ (US); Yutian Pang, Milpitas, CA (US); Jueming Hu, Milpitas, CA (US)

(73) Assignee: Arizona Board of Regents on Behalf of Arizona State University, Tempe, AZ (US)

(21) Appl. No.: 19/380,809

(22) Filed: Nov. 5, 2025

Related U.S. Application Data
(60) Provisional application No. 63/717,760, filed on Nov. 7, 2024.

(51) Int. Cl. G08G 5/54; G06N 20/00; G06Q 10/047

(52) U.S. Cl. CPC G08G 5/54; G06N 20/00; G06Q 10/047

(57) ABSTRACT

A method for machine learning enhanced aircraft landing scheduling which takes into account airspace uncertainties is disclosed. The model obtains aviation source data from a data warehouse, which is processed into organized feature representations. The boosting model takes the feature representations and fits them into base learners sequentially and concatenates them for the best set of base learners. The boosting model then predicts the distribution of landing times for each landing aircraft, considering uncertainties between successive flights, which is used as a constraint in the traveling salesman problem with time window constraints. The traveling salesman problem is then used to determine an optimal aircraft landing schedule using the distribution of landing times.

### CROSS REFERENCE TO RELATED APPLICATIONS

This is a non-provisional application that claims benefit to U.S. Provisional Application Ser. No. 63/717,760 filed on Nov. 7, 2024 which is hereinincorporated by reference in its entirety.

### GOVERNMENT SUPPORT

This invention was made with government support under NNX17AJ6A awarded by the National Aeronautics and Space Administration. The government has certain rights in the invention.

### FIELD

The present disclosure generally relates to aircraft scheduling, and more specifically to use of machine learning models to determine optimal aircraft landing schedules.

### BACKGROUND

The civil aviation industry is losing air traffic control talents, while the need for maintaining daily operations keeps surging. This situation leads to increased operational costs, higher safety concerns, an elevated workload for air traffic controllers, and frequent flight delays. Flight delay is a major problem of interest faced by domain experts, which results in both economic and customer loyalty losses. It is reported that 20% of the civil flights in the U.S. were delayed from 2010 to 2018, and the annual cost of delays before the pandemic is estimated to be $30 billion. The initial flight delays come from various sources (e.g., extreme weather conditions, carrier and controller issues) and can propagate through several hours. Moreover, the aviation industry is encountering a shortage of experienced operation talents after the COVID-19 pandemic due to various reasons (e.g., loss of operational and airline experience, staffing, and changing customer demand patterns). All of this urges the automation and digitization of the aviation industry in a regulated fashion, which heavily relies on innovative data-driven modeling techniques.

Automated computer-aided decision support tools (DSTs) are practical solutions to address safety and efficiency concerns (e.g., flight delays), with the help of modernized data monitoring and recording equipment. DSTs will help maximize the operational capacity of the terminal maneuvering area (TMA), where the optimization of departure/arrival operations in the TMA is a critical problem of air traffic control (ATC). In most cases, the heuristic decision by the ATC will be suggested together with a graphic view of each corresponding location and speed of the aircraft near the TMA. This setup is efficient on normal operations but leads to flight delays and elevated controller workload during extreme scenarios. The unfolded diamond shape symbols in the graphic view may overlap and lead to significant delays during certain extreme cases. DSTs are developed to alleviate flight delays and maximize operational capacity during certain cases and busy traffic. For instance, the measurement coverage of NextGen will be enlarged to hundreds of nautical miles (NM) due to the advanced surveillance radar for the Automatic Dependent Surveillance-Broadcast (ADS-B) system. The enlarged surveillance measurement space enables the possibility of developing optimization-based DSTs, to be applied in the en-route phase. Lastly, DSTs assist controllers in suggesting reasonable resolutions by searching from historical data or learning from human preferences. Various government agencies proposed advanced DST system concepts. Airport Collaborative Decision Making (A-CDM) concept and Next Generation Air Transportation System (NextGen) was proposed by the European Organization for the Safety of Air Navigation (EUROCONTROL) and Federal Aviation Administration (FAA) to assist air traffic controllers in decision makings, with enhanced safety, efficiency, and capacity. Field demonstrations on either single-airport or multi-airport scenarios show great safety enhancements and efficiency improvements.

It is with these observations in mind, among others, that various aspects of the present disclosure were conceived and developed.

### BRIEF DESCRIPTION OF THE DRAWINGS

FIG. 1 is a boxplot depicting the time spent from 100 NM to 40 NM for landing aircraft entering the TMA of KATL during the month of August 2019.

FIG. 2 show box diagrams of the proposed machine learning-enhanced optimization model for aircraft landing scheduling.

FIGS. 3A and 3B show graphical depictions of the flight landing progress recording during busy hours.

FIG. 4 is a plot of flight tracks of for landing aircraft.

FIG. 5 depicts plots of landing aircraft coming from the northeast for west landing.

FIG. 6 depicts plots of landing aircraft coming from the northwest for west landing.

FIG. 7 is a visualization of IFF flight track data from the FAA Atlanta Air Route Traffic Control Center.

FIGS. 8A and 8B show graphical depictions of data analysis to identify the reasonable conditions for conditioned prediction.

FIG. 9 shows graphical depictions of the evaluation results in comparison for unconditioned predictions and conditioned predictions.

FIG. 10 shows plots depicting the corresponding variable (feature) importance for conditioned predictors.

FIG. 11 shows a scatterplot of time spent for approaching flights around KATL terminal maneuvering area.

FIG. 12 shows graphical representations of landing trajectories for two case studies on KATL runway.

FIG. 13 shows graphical representations of the experimental results for the three case studies with landing flights.

FIG. 14 is a block diagram of the computer implemented system suitable for implementing the machine learning enhanced aircraft landing scheduling method under uncertainties according to embodiments disclosed herein.

Corresponding reference characters indicate corresponding elements among the view of the drawings. The headings used in the figures do not limit the scope of the claims.

### DETAILED DESCRIPTION

The present disclosure relates to systems and methods for scheduling aircraft landings through the application of machine learning-enhanced methodologies to enhance automation and safety under uncertain conditions.

In some aspects, the techniques described herein relate to a system for determining an optimal aircraft landing schedule, including: a memory; and a processor having access to a set of executable instructions located on the memory which, when executed, cause the processor to: retrieve, from the memory, historical flight data; process, using the processor, the historical flight data into feature representations; sequentially fit, using the processor, the processed feature representations into base learners using a machine learning model; training the machine learning model to predict landing times for any successive approaching aircraft pair of a plurality of approaching aircraft using the base learners for an airport; predict, using the trained machine learning model, a distribution of landing times for the successive approaching aircraft pair, wherein the prediction incorporates uncertainties between successive flights within the historical flight data; and determine, using a traveling salesman problem formulation with time window constraints, an aircraft landing schedule for the plurality of approaching aircraft for the airport based on the distribution of predicted landing times.

In some aspects, the techniques described herein relate to a system, wherein the machine learning model determines a minimum separation time for the successive approaching aircraft pair.

In some aspects, the techniques described herein relate to a system, wherein the historical flight data includes nearby flight event situations and airspace complexity measurements.

In some aspects, the techniques described herein relate to a system, wherein the machine learning model is a gradient boosted machine with weighted quantiles.

In some aspects, the techniques described herein relate to a system, wherein the traveling salesman problem is further constrained by a minimum aircraft separation time and fuel consumption.

In some aspects, the techniques described herein relate to a system, wherein the plurality of approaching aircraft includes all approaching aircraft within a range of about 100 to about 200 nautical miles from the airport.

In some aspects, the techniques described herein relate to a system, wherein the processor determines the aircraft landing schedule for one runway of the airport.

In some aspects, the techniques described herein relate to a system, wherein the processor determines the aircraft landing schedule for two or more runways of the airport.

In some aspects, the techniques described herein relate to a system, wherein the processor has access to further instructions which, when executed, cause the processor to increase or decrease a speed of an approaching aircraft of the plurality of approaching aircraft.

In some aspects, the techniques described herein relate to a system, wherein the aircraft landing schedule is determined by minimizing a total time required for approaching for the plurality of approaching aircraft while satisfying the predicted landing times.

In some aspects, the techniques described herein relate to a method for aircraft landing schedule optimization, including: receiving, at a processor, aviation data for a plurality of approaching aircraft; predicting, using a machine learning model, a landing time and an uncertainty interval for each approaching aircraft of the plurality of approaching aircraft, wherein the machine learning model is trained on historical flight data; determining, using the machine learning model, a minimum separation time for any successive pair of approaching aircraft of the plurality of approaching aircraft based on the predicted landing time and uncertainty interval; determining, using a traveling salesman problem with time window constraints, an aircraft landing schedule for the plurality of approaching aircraft for an airport, wherein the time window constraints include the minimum separation time, predicted landing time, and uncertainty interval.

In some aspects, the techniques described herein relate to a method, wherein the historical flight data is filtered to include historical flight data for flights where the time spent within about 100 NM to about 40 NM of the airport by an aircraft corresponds to a historical average time spent within about 100 NM to about 40 NM of the airport where at least 40 loop events have occurred.

In some aspects, the techniques described herein relate to a method, wherein the machine learning model is a gradient boosted machine with weighted quantiles.

In some aspects, the techniques described herein relate to a method, wherein the machine learning model predicts the landing time and uncertainty interval taking into account uncertainties between successive flights within the historical flight data.

In some aspects, the techniques described herein relate to a method, wherein the plurality of approaching flights includes all approaching aircraft within a rolling time window to be scheduled.

In some aspects, the techniques described herein relate to a method, wherein the plurality of approaching flights includes all approaching aircraft within 100 NM to about 200 NM of the airport.

In some aspects, the techniques described herein relate to a method, wherein the travelling salesman problem is further constrained by fuel consumption.

In some aspects, the techniques described herein relate to a method, further including: instructing, by the processor, an approaching aircraft to increase or decrease its speed according to the determined aircraft landing schedule.

In some aspects, the techniques described herein relate to a method, further including: increasing or decreasing a speed of an approaching aircraft of the plurality of approaching aircraft according to the determined aircraft landing schedule.

In some aspects, the techniques described herein relate to a method, wherein the aircraft landing schedule is determined by minimizing a total time required for approaching for the plurality of approaching aircraft while satisfying the predicted landing time.

Aircraft delays lead to safety concerns and financial losses, which can propagate for several hours during extreme scenarios. Developing an efficient landing scheduling method is one of the effective approaches to reducing flight delays and safety concerns. Existing scheduling practices are mostly done by air traffic controllers (ATC) with heuristic rules. This disclosure proposes a novel machine learning-enhanced methodology for aircraft landing scheduling. Data-driven machine learning (ML) models are proposed to enhance automation and safety. ML enhancement is adopted for both prediction and optimization. First, the flight arrival delay scenarios are analyzed to identify the delay-related factors, where strong multimodal distributions and arrival flight time duration clusters are observed. A multi-stage conditional ML predictor is proposed for improved prediction performance of separation time conditioned on flight events. The present disclosure proposes incorporating the ML predictions as safety constraints of the time-constrained traveling salesman problem formulation. The scheduling problem is then solved with mixed-integer linear programming (MILP). Additionally, uncertainties between successive flights from historical flight recordings and model predictions are included to ensure reliability. The real-world applicability of the present method is demonstrated using the flight track and event data from the Sherlock database of the Atlanta Air Route Traffic Control Center (ARTCC ZTL). The case studies provide evidence that the proposed method is capable of reducing the total landing time by an average of 17.2% across three case studies, when compared to the First-Come-First-Served (FCFS) rule. Unlike the deterministic heuristic FCFS rule, the disclosed methodology also considers the uncertainties between aircraft and ensures confidence in the scheduling. Several concluding remarks and future research directions for the presently disclosed methods and systems are also provided.

To achieve this goal, it is important to understand and solve different challenges.

While the government-led efforts mostly focus on building the system workflow for onboard deployment, academic research focuses on algorithmic development and advanced data analytics to enable automated decision-making to support aviation digitization. The Aircraft Landing Scheduling (ALS) problem is vital to overcome flight delays and achieve efficient aviation operations in the TMA. ALS studies the planning of the landing schedule for all the aircraft landed on the same runway in a short time period, where the runway capacity is pre-defined based on the existing infrastructure. In aviation, the ALS problem is viewed as a critical element of the general planning system of aircraft around the TMA. Researchers who are studying ALS focus on the following objectives: (1) Maximize the fuel efficiency by arranging the landing aircraft at the most economic landing times and speed profiles; (2) Minimize the difference to the flight schedules; (3) Maximize the runway throughput by minimizing the total landing time.

The present disclosure focuses on the third item, i.e., maximizing the runway throughput. During arrivals, the air traffic controllers (ATCs) give instructions to the pilots when the aircraft enters the range of the terminal surveillance radar. Thus, ATCs provide guidance for safe and effective landings. Landing safety is enforced by the Minimum Separation Time (MST) between two landing aircraft. The MST is introduced to account for aerodynamic safety considerations. For instance, when the leading aircraft is much heavier than the following aircraft, the leading aircraft's wake vortices will result in hazardous conditions for the following lighter aircraft within MST and poses immediate safety concerns. The ALS problem has been formulated into two sub-problems. Firstly, the order of the aircraft entering the TMA is determined. Then, the exact scheduled landing time is determined based on the landing sequence and MST. These two steps can be collaboratively solved with proper optimization algorithms. The extension of the surveillance area enables the possibility of developing a novel landing scheduling scheme that can be performed in the enroute phase rather than only in the terminal area to prevent congestion and reduce congestion-related safety concerns. However, the current literature either focuses on formulating the optimization problem in both static and dynamic scenarios with synthetic examples or considering one of the related factors during sequencing to formulate the mathematical model (e.g., ground staff workload, airline preferences). The above pure simulated demonstration limits the applicability and generalizability of the developed algorithms to be deployed in the real world.

The availability of a well-maintained aviation data warehouse has enabled the possibility of learning and generating aviation operational decisions from realistic operational data. Machine Learning (ML) is an example of data analytics that draws interest from both academia and industry. In the ATM domain, the use of ML techniques also surges in recent years, although multiple challenges (i.e., data privacy/collection/storage/integrity, system reliability, and scalability) still exist when deploying ML systems into real-world (MLOps). Compared to the conventional methods, ML methods show the following benefits: (a) A ML-based DST takes advantage of realistic historical data to simulate the human experience accumulation process, where the model can provide experienced guidance within the machine response time; (b) ML methods are highly flexible to fuse structured or unstructured data from various sources for decision-making. Nonetheless, criticisms against ML methods also rise regarding model interpretability/explainability, prediction generalizability, and output trustworthiness. It was believed that ML-based DSTs are beneficial for computer-assisted decision-making under the supervision of human controllers.

In view of the above discussion, there is a need and gap to develop data-driven aircraft landing scheduling algorithms from extended airspace to maximize runway throughput and reduce flight delays. The present disclosure will first investigate and identify several factors causing flight delays through data analysis. Then, a data-enhanced optimization technique for ALS is proposed, where the statistics of MST is incorporated into the safety-critical constraints under the Traveling Salesman Problem (TSP) formulation. The probabilistic MST is learned with a conditional tree-based ML method, namely a conditional gradient boosting machine (conditional GBM) with quantile distributions to retrieve the upper and lower bounds of MST. Following this, an optimal method using TSP formulation solved by mixed-integer linear programming (MILP) is proposed for sequencing to minimize total delay while taking into account the uncertainty of arrival time prediction.

The contributions of the present disclosure can be summarized as
Investigate several arrival delay scenarios that occurred in the historical data and gain the following insights, (a) the arrival time of aircraft has a highly multimodal distribution conditioned on the flight events; (b) go around (looping)—the event happened in most arrival delay scenarios—occurs at approximately 100 nautical miles away from the terminal, where FCFS rule starts to take effect; (c) the preference of landing scheduling made by human controllers may not be optimal (e.g., landing aircraft from west of terminal should yield to other directions on a west heading runway); (d) including weather features can further improve the landing time prediction accuracy. These observations give insights into identifying relevant impact factors in building ALS solutions.
The statistics of MSTs are predicted with a tree-based probabilistic machine-learning algorithm from the historical flight recordings. The obtained probabilistic MSTs are incorporated as safety constraints to the time-constrained traveling salesman problem. The present type of probabilistic scheduling setting as used in the presently disclosed methods is the first time.
It is proposed use a conditional ML predictor based on the event counts within a certain distance of the target aircraft to improve the prediction performance. Geographical location, speed profiles, flight event counts, weather features, and airspace complexity measures are integrated together for probabilistic prediction of arrival time, which has not been explored in the open literature.
The proposed framework shows a reduction in total aircraft landing time compared to the FCFS rule, through case studies during busy operation hours at KATL. The proposed method takes effect from extended airspace (e.g., en-route phase flights 200 NM away from the terminal), such that early adjustment of aircraft speed profiles can be issued to avoid holding patterns.

### Literature Review

This section discusses the related literature to our proposed study on data-enhanced ALS. The studies for the prediction of aircraft estimated arrival time (ETA) and MST are first reviewed, then the research on aircraft landing scheduling problems are reviewed.

### Estimated Arrival Time Prediction and Minimum Separation Time (MST)

Landing aircraft move along the predefined landing procedures with standard descending profiles when entering the terminal maneuvering area (TMA), with the help of necessary guidance from ATCs. The MST between two consecutive landing aircraft should be guaranteed in the approaching phase. The MST depends on the types and relative positions of two consecutive landing aircraft, which can be translated by considering the speed profiles. Once a landing aircraft enters TMA, it should line up and proceed to the runway. However, delays happen on a daily basis and can propagate from ground to mid-air airplanes due to the sub-optimal scheduling of runway usage. In this case, ATC issues a holding order to the approaching aircraft and forces the aircraft to circle around and wait for the clearance to land. The conservative determination of the landing safety buffer will result in lower runway throughputs, with larger landing intervals between landing aircraft. In extreme cases (e.g., severe convective weather conditions), the delay might be very significant and prolonged due to high congestion and weather uncertainties. Real-time traffic management systems (e.g., Integrated Arrival Departure Surface Traffic Management by NASA) consider potential conflicts by constantly adjusting the group of aircraft within TMA in terms of re-routing, re-timing, and holding.

To properly include MST as the safety-critical landing buffer time with various operational uncertainties, the ETA along with the corresponding ETA confidence interval are predicted. The prediction of ETA usually happens upon the aircraft entering the TMA, which is usually 40 min ahead of landing. Early works to predict arrival time focus on using physics-based trajectory models, which are usually associated with the aircraft performance, flight plan, and the predicted atmospheric conditions provided by flight-desk systems. In Krozel et al. (1999), a method is proposed to predict the arrival time in heavy weather conditions using the aircraft dynamics and weather avoidance algorithm. Estimated time of arrival time prediction is approached from a hybrid linear system in Roy et al. (2006), then the chosen route probability is further incorporated for stochastic arrival time prediction. A state-dependent hybrid estimation method is used for improved prediction accuracy in Wei et al. (2015). Many 4D trajectory prediction algorithms with various kinematic assumptions can also provide an estimated time of arrival.

Data-driven methods for arrival time prediction have increased rapidly in recent years, due to the rise of machine learning and well-maintained data storage facilities. Tree-based methods have been used to predict air traffic delays, where the weather-related features are taken into account to enhance arrival time prediction capabilities. However, tree-based methods with quantile regression have not been used for uncertainty quantification of arrival time predictions. Deep learning methods, such as recurrent neural networks (RNN), are also adopted for arrival time prediction under different circumstances. Moreover, the importance of feature selection in air traffic prediction is discussed in Dhief et al. (2020). The experiments with extended TMA conclude that when building machine learning models for air traffic prediction tasks, feature selection with the help of domain knowledge is critical. The model performance is less sensitive to the selection of machine learning algorithms itself. This also guides the discoveries on feature studies and case analysis in the later sections of this disclosure.

### Aircraft Landing Scheduling

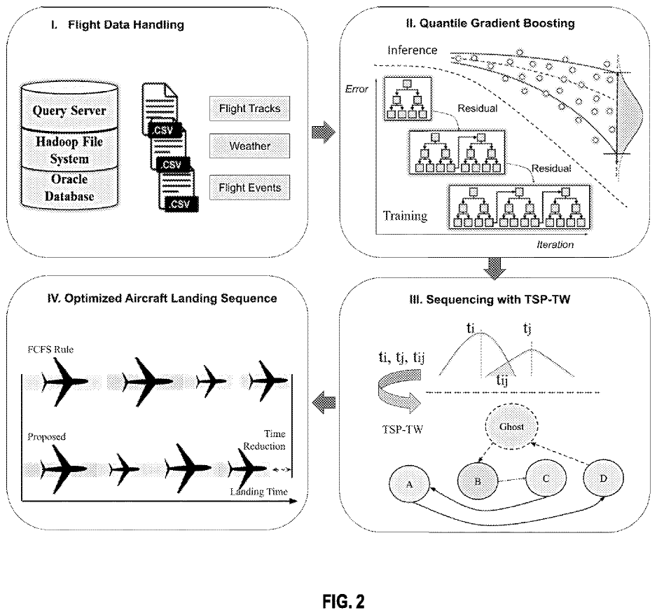

The definition of the ALS problem is as follows. Assume that there are n aircraft lining up for landing on a single runway. The objective of the ALS problem is to find a schedule of the respective landing time {t₁, t₂, . . . , tᵢ} for each aircraft {1, 2, . . . , i}. In ALS, there are two constraints to be satisfied: (1) the aircraft must land within a specific time period; (2) the minimum separation time between each pair of landing aircraft should be guaranteed. The common practice for ALS used by ATC is following the First-Come-First-Served (FCFS) rule, where the scheduled landing sequence is consistent with the time for each aircraft entering the TMA. FCFS is convenient to maintain safe landing operations but can lead to severe delays during busy hours (e.g., FIGS. 3A and 3B). The FCFS rule has several known drawbacks, (a) the lower speed leading aircraft will impact the following aircraft, even if the following aircraft has higher ground speed; (b) the FCFS rule can create unnecessary long separations for aircraft with different weight classes; (c) when terminal area congestion presents, the aircraft reaching TMA will hold and poses significant delays to wait for the clearance of congested aircraft; (d) the delay will easily propagate to several hours in extreme scenarios.

Thus, many researchers have proposed different approaches to optimizing the aircraft landing sequence within the scheduling range. The ALS problem can be formulated into a mixed-integer programming problem, where the relationship to machine scheduling problem has been exploited in the literature. Researchers propose a variety of algorithms to address the ALS problem: (1) the ALS problem can be classified into dynamic and static scheduling approaches, depending on whether the environment is dynamically changed or not; (2) the scheduling algorithm itself considers various impact factors and objective functions, such as airlines' preferences, ground workload, and cellular automation; (3) consider the ALS problem from limited airspace or extended airspace. A detailed review of the above-mentioned three major perspectives is given below.

Static Scheduling v.s. Dynamic Scheduling: Static aircraft landing scheduling defines the ALS problem with a predetermined time window, such that the scheduling constraints are ensured. Beasley et al. (2000) proposes a mixed-integer zero-one formulation of ALS for both single and multiple runway scenarios, to consider commonly encountered issues in practice (e.g., restricting the number of total landings in a given period). The problem is further solved with linear programming-based tree search. Ding and Valasek (2007) proposes a static optimization algorithm for aircraft landing in a single-runway, uncontrolled airport, with performance metrics such as total holding time and total landing time. Some other researchers view dynamic programming as a feasible approach to ALS. Faye (2015) adopts Beasley et al. (2000)'s formulation but with a novel dynamic constraints generation algorithm. The proposed algorithm approximates the MST into a rank two matrix, which leads to linear programming with relaxation. The dynamic ALS problem received less attention in the literature and is usually achieved with the same approach called rolling horizon. Rolling horizon is as simple as rolling the time window of agents for optimization. Firstly, the aircraft inside TMA within the rolling horizon (typically several minutes) are optimized. Then, the landed aircraft are removed from the rolling horizon, and the new aircraft just entered the rolling horizon are added to the algorithm. Ciesielski and Scerri (1997) solves dynamic ALS with genetic algorithms using data from Sydney airport, and shows that the genetic algorithm can perform good results in real-time with a rolling horizon of 3 min.

Optimization Objectives & Related Factors: Researchers working on the ALS problem consider various impact factors with different optimization objectives. In Beasley et al. (2000), the authors focus on reducing the deviation from the scheduled landing times. A linear programming-based tree search method was proposed for landing scheduling, building upon the pioneering work of mixed-integer programming formulation for ALS. Similarly, Beasley et al. (2001) extend the work to reduce deviations from scheduled landing times under time window constraints, but the MSTs are pre-defined for five different aircraft weight classes. Based on the tree search approach proposed in Beasley et al. (2000), Soomer and Franx (2008) considers airline preferences into the optimization framework, in which the optimal landing sequences are given by tree search and MILP is used to determine the optimal landing time. Dynamic programming-based landing sequencing method is proposed in Balakrishnan and Chandran (2006) to maximize the runway throughput. Balakrishnan and Chandran (2006) achieves a highly satisfactory result, but the concern on computational complexity limits the real-world applicability. Studies on alleviating computational complexity are also conducted, such as the cellular automaton optimization method, ant colony optimization method, genetic algorithm, and population heuristic algorithm.

TMA Scheduling Range: There have been several studies focusing on changing the range of the TMA for ALS. Some of the researchers propose to perform landing scheduling on the entire TMA, to consider the ALS problem from a systematic view. D'Ariano et al. (2012, 2015) divide the ATC controls into routing decisions, scheduling decisions, and air segments and runways. Then, a job shop formulation is used to reduce the delay caused by conflicts in TMA. More recently, researches on arrival management suggest that performing aircraft sequencing in an extended area rather than in TMA is actually an effective solution. This concept allows ATCs to monitor and control traffic into a busy terminal area from the en-route phase, enabling aircraft to adjust their speed before their top of descent. Thus, time spent in mid-air holding in the TMA can be reduced. In Toratani et al. (2018), an algorithm is developed using the merging optimization method to simultaneously optimize trajectories, arrival sequence, and allocation of aircraft to parallel runways. A two-stage stochastic mixed-integer programming model is proposed in Khassiba et al. (2020). Another study assessed the effect of flights departing on extended arrival management, in terms of flight crew and air traffic control task load, sequence stability, and delay. Two-stage stochastic programming is presented in Khassiba et al. (2019) to address the arrival sequencing and scheduling problem under uncertainty.

Ikli et al. (2021) provides a comprehensive review of optimization methods for the aircraft runway scheduling problem, covering exact methods, metaheuristics, and new approaches such as reinforcement learning. The manuscript identifies analogies with classic problems like traveling salesman and vehicle routing that provide insights. Notably, this paper constructs new challenging test instances from real air traffic data to serve as a benchmark for ALS studies. It provides a thorough overview of optimization techniques for the ALS problem and sets the stage for future research by identifying the limitations of current approaches and proposing new benchmark instances. The major limitation is the lack of uncertainty handling for real-world settings.

Several existing gaps can be identified from the above review. For example, the existing landing scheduling methods assume the actual arrival times to deviate randomly from target times (calculated using the en-route speeds) to infer MST. Also, the scheduling algorithm assumes a pre-defined MST based on the aircraft weight classes. In practice, there is tremendous uncertainty associated with the arrival time prediction, which violates the assumptions of deterministic separation. Several factors, such as aircraft type, weather conditions, and airspace density information can be explicitly acquired in the aviation database and should be used to reduce the uncertainties of arrival time prediction. In addition, the assumption of static and fixed arrival time distributions is not valid and may cause ineffective landing scheduling and/or unsafe separation between aircraft (examples shown later using realistic data). The exact arrival time prediction with accurate uncertainty quantification for each landing aircraft should be determined, which further optimizes landing schedules for all of the landing aircraft with an ensured confidence level. Thus, the main focus of this disclosure is to develop a real-world data-enhanced landing scheduling algorithm to achieve optimal landing scheduling with uncertainties.

### Methodologies

This section demonstrates the methodologies for ML-enhanced ALS. The tree-based machine learning selected—Gradient Boosting Machine (GBM) with quantile regression will first be illustrated. Then, the necessary background to the Traveling Salesman Problem will be provided and the formulation of time-constrained TSP formulation to solve the ALS problem is introduced. Following this, the proposed approach to integrating machine learning prediction of arrival time into time-constrained TSP formulation is described.

### Gradient Boosting Machine

Although the literature has concluded that selecting the correct feature set is more advantageous than pursuing the most advanced machine learning algorithms, tree-based machine learning algorithms were chosen due to their proven outstanding performances on structured data. Furthermore, across various tree-based machine learning algorithms, boosting is selected over simple trees or bagging. The benefits of boosting are threefold, (a) Boosting methods add new base learners to the ensembles at each iteration, and each base learner has trained w.r.t. the residual from the current ensembles. As a result, this iterative process helps to reduce bias and increase model accuracy. (b) Boosting provides feature importance as the indicator of critical features, which is valuable for feature selection and understanding the input-output relations. (c) Boosting can capture complex patterns by capturing complex decision boundaries over simple trees and bagging. Gradient Boosting Machine (GBM) is a commonly used model. GBM connects boosting and optimization to perform gradient descent on both the loss functions and the base learners. The exceptional performance of GBM on ETA prediction is also concluded by a recent study.

Considering a supervised learning problem with structured data [symbol] {(xᵢ,yᵢ)|i=0, . . . , n}, where xᵢ∈ [symbol] ^{M} is also called the feature vector of the ith sample with M different features, and yᵢ is the continuous response as the label of xᵢ in a regression problem. In GBM, there are a set of base learners; [symbol] ={b_{γ}_{ₘ}(x)∈ [symbol] ^{M}} parameterized by γₘ. In GBM, the predictions are the linear combination {B} of the predictions from each of the base learner b_{γ}_{ₘ}(x)∈ [symbol] , where each of the base learners is additively learned with pseudo-residuals (Tₘ). The corresponding predicted label to feature vector xᵢ is f(xᵢ)∈lin{ [symbol] }, in the form of,

$$f ( {x}_{i} ) = {\sum }_{m = 0}^{M} {α}_{m} {b}_{{γ}_{m}} ( {x}_{i} ) \qquad ( 1 )$$

where αₘ is the coefficient for each base learner b_{γ}_{ₘ}(x)∈ [symbol] . Examples of base learners include linear models, support vector machines, classification, and regression trees. Additionally, for the most popular tree-based learners set, the GBM turns into Gradient Boosted Decision Trees (GBDTs). GBM aims to obtain the best function set \hat{f}(xᵢ)∈lin{ [symbol] } to minimize the given data-fidelity evaluation function (e.g., least squared residual loss for simple regressions).

$$\hat{f} ( {x}_{i} ) = arg {min}_{f ( {x}_{i} ) ∈ lin \{ ℬ \}} {\sum }_{i = 0}^{n} {ξ}_{i} ( {y}_{i} , f ( {x}_{i} ) ) \qquad ( 2 )$$

where ξᵢ(i(yᵢ,f(xᵢ)) is the data-fidelity evaluated at the ith feature vector.

Using the defined notations above, the GBM minimizes the loss function by calculating the steepest descent to the objective function defined in Eq. (2), where the steepest gradient is determined with line-search on the best base learner parameter set \hat{γ}ₘ.

The following research explores the possibility of improving the boosting method performance from many perspectives.
Introduce a learning rate A to the updating equation of f(x): f^{m+1}(x)=f^{m}(x)+λρₘb_{λ}_{ₘ}(x). Multiplying A provides the damping of controlling the rate of descent on the error surface.
Sampling without replacement from the dataset before the gradient calculation step gives stochasticity to GBM, and greatly improved the performance of the algorithm.
Using ANOVA decomposition can restrict the depth of the trees, which further controls the order of approximations of GBM: f(x)=Σᵢfᵢ(xᵢ)+Σᵢⱼfᵢⱼ(xᵢ,xⱼ)+Σᵢⱼₖfᵢⱼₖ(xᵢ,xⱼ,xₖ)+ . . .

Specifically, GBMs can be turned into probabilistic predictors when applying quantile distributions to the response variable. The gradient calculation of τₘ changes to the quantile pseudo-residual τₘ=βξ(γᵢ≥f(xᵢ))−(1−β)ξ(γᵢ≤f(xᵢ)), where

$$β = \frac{{\sum }_{i = 0}^{n} {ω}_{i} {ξ}_{i} ( {y}_{i} \leq q )}{{\sum }_{i = o}^{n} {ω}_{i}}$$

and q denotes the weighted quantile. With the GBM prediction label of the defined quantile, given a test sample \hat{x}ᵢ, the confidence interval σ along with the prediction \hat{γ}ᵢ can be obtained.
Traveling Salesman Problem with Time Windows (TSP-TW)

The ALS problem involves landing sequencing and landing scheduling, which is a discrete optimization problem in nature. Combinatorial optimization tackles discrete optimization problems from the intersection of combinatorics and theoretical computer science. TSP-TW is a classical combinatorial optimization problem. The original definition of TSP-TW aims at finding the optimal tour that minimizes the length of the tour and visits each node once within the specified time window [lᵢ,uᵢ], where lᵢ and uᵢ are the lower and upper bound for visiting time of node i. The bounded time windows set time constraints to the agent traveling within the node graph and mark the significant difference to classical TSP problems. The present disclosure proposes to use TSP-TW for ALS and incorporate the machine learning predicted aircraft ETAs into the constraints of TSP-TW.

Define an undirected graph G=(V,A) with a finite set of nodes, V={0, 1, . . . , n}, and a finite set of edges, A={(i,j)|i≠j,i,j∈V}. TSP-TW determines the time tᵢ that the agent visits node i∈{0, 1, . . . , n}. Meanwhile, an additional variable, tₙ₊₁, is introduced to represent the completion time of the tour, as the agent has to return to node 0 at the end of the tour. A distance matrix, tᵢⱼ, records the shortest distance between each node pair, which can be further treated as the scalar transformation of time distance between node pairs. Mathematically, the classical formulation of TSP-TW is shown in Eqs. (3)-(8).

$$min {t}_{n + 1} \qquad ( 3 )$$

$$subject to$$

$${t}_{i} - {t}_{0} \geq {t}_{0 i} i = 1 , 2 , … , n \qquad ( 4 )$$

$$\vert {t}_{i} - {t}_{j} \vert \geq {t}_{i j} i = 2 , 3 , … , n ; 1 \leq j < i \qquad ( 5 )$$

$${t}_{n + 1} - {t}_{i} \geq {t}_{i 0} i = 1 , 2 , … , n \qquad ( 6 )$$

$${t}_{i} \geq 0 i = 0 , 1 , … , n + 1 \qquad ( 7 )$$

$${l}_{i} \leq {t}_{i} \leq {u}_{i} i = 1 , 2 , … , n \qquad ( 8 )$$

To solve TSP-TW, there are several methods spanning from mathematical programming approaches to heuristic approaches. Mixed-Integer Linear Programming (MILP) techniques are commonly used approaches to solve TSP-TW. Despite the difference between problem setups and applications, researchers propose various methods to solve TSP-TW with MILP for up to 200 clients. Additionally, constraint programming methods are proposed to develop both exact and heuristic solvers for TSP-TW. While in this work, the MST is incorporated into the constraints (Eqs. (9)-(16)) of the TSP-TW model, keeping the original objective function in Eq. (3).

$${t}_{i} \geq {t}_{0 i} \cdot {y}_{0 i} i = 1 , 2 , … , n \qquad ( 9 )$$

$${t}_{i} - {t}_{j} + ( {u}_{i} - {l}_{j} + {t}_{i j} ) \cdot {y}_{i j} \leq {u}_{i} - {l}_{j} ∀ i , j = 1 , 2 , … n : i \neq j \qquad ( 10 )$$

$${\sum }_{i = 0}^{n} {y}_{i j} = 1 j = 1 , 2 , … , n \qquad ( 11 )$$

$${\sum }_{j = 0}^{n} {y}_{i j} = 1 i = 1 , 2 , … , n \qquad ( 12 )$$

$${t}_{i} + {t}_{i 0} \leq {t}_{n + 1} i = 1 , 2 , … , n \qquad ( 13 )$$

$${l}_{i} \leq {t}_{i} \leq {u}_{i} i = 1 , 2 , … , n \qquad ( 14 )$$

$${y}_{i j} ∈ \{ 0 , 1 \} ∀ ( i , j ) ∈ \{ ( i , j ) : i , j ∈ 0 , 1 , … , n \} \qquad ( 15 )$$

$${t}_{i} \geq 0 ∀ i = 0 , 1 , … , n + 1 \qquad ( 16 )$$

The objective is to minimize the total landing time for all landing aircraft. uᵢ and lᵢ denote the earliest and latest time for aircraft i to land, respectively. uᵢ−lᵢ indicates the maximum allowed flight time of aircraft i, which can reflect the aircraft conditions (e.g., fuel, pilot fatigue level, etc.). yᵢⱼ is the adjacency matrix, defined as,

$${y}_{i j} = \{ \begin{matrix}1 , & if aircraft j lands right after aircraft i , \\ 0 , & otherwise .\end{matrix} \qquad ( 17 )$$

Eq. (10) describes the constraint on the separation requirement between two consecutive intermediate aircraft. tᵢⱼ denotes the MST from aircraft i to aircraft j. The following will discuss the method used to incorporate GBM predicted MST into tᵢⱼ. As MST depends on the wake turbulence generated by the leading aircraft, the formulation is an asymmetric TSP-TW problem, indicating tᵢⱼ≠tⱼᵢ. The time window for the agent to visit a node corresponds to the specified time range for the aircraft to start to land, considering the fuel consumption and aircraft dynamics. Eqs. (9) and (13) guarantees that the smallest and largest tᵢ values. Eqs. (11), (12) and (15) ensure that each aircraft will land exactly once. Eq. (14) introduces the pre-determined time schedule of each aircraft. In practice, the model in Eq. (3) is solved with GLPK solver and Python Optimization Modeling Objects (Pyomo) package.

TABLE 1 [symbol]
: Minimum required time-space (s) used
by arrival manager (Erzberger et all, 2016).

Trailing aircraft

| | | | | | |
|---|---|---|---|---|---|
| Leading | | Heavy | B757 | Large | Small |
| Aircraft | Heavy | 82 | 118 | 118 | 150 |

| | | | | |
|---|---|---|---|---|
| B757 | 60 | 64 | 64 | 94 |
| Large | 60 | 64 | 64 | 94 |
| Small | 60 | 64 | 64 | 94 |

### Incorporating Uncertainties of MST Constraints to TSP-TW

As reviewed earlier, there are tremendous uncertainties associated with the estimated arrival time and minimum separation time. Thus, the proposed method will include uncertainties in the landing scheduling problem to ensure confidence. For each successive landing aircraft pair (i,j), GBM with weighted quantile gives the predicted landing time distributions since entering the extended TMA for variable tᵢ and tⱼ from real-world data.

For each successive landing aircraft pair (i,j), GBM with weighted quantile gives the predicted landing time distributions for variable tᵢ and tⱼ from real-world data. It is assumed that arrival time for landing aircraft follows i.i.d. Gaussian distributions. The MST is defined as the difference between the two arrival times for the two aircraft (i,j). Thus, the MST can be expressed

$${t}_{i j} ∼ 𝒩 ( {𝒯}_{ij} , {σ}_{ij} ) \qquad ( 18 )$$

where [symbol] is the referenced MST between aircraft i and j by the related authorities.

$${σ}_{i j} = \sqrt{{σ}_{i}^{2} + {σ}_{j}^{2}}$$

represents the uncertainty of MST from the quantified uncertainties (standard deviation) from the arrival time of the two aircraft (i,j). The major reference values of [symbol] are listed in Table 1.

Given a fixed spacing conflict probability P_{c}, the MST between landing aircraft i and j, [symbol] ᵢⱼ can be calculated,

$${\check{\check{t}}}_{i j} = {Φ}_{{t}_{i j}}^{- 1} ( {P}_{c} ) \qquad ( 19 )$$

where [symbol] ᵢⱼ forms the separation constraints in Eq. (3). By Eq. (19), the minimum allowable separation time between two successive landing aircraft pair (i,j) is obtained as [symbol] ᵢⱼ. It is worth pointing out that [symbol] ᵢⱼ is different from [symbol] ⱼᵢ, since the MSTs are significantly impacted by the leading aircraft. Additionally, the predicted mean values of estimated landing times uᵢ and uⱼ are included in the upper and lower bound (uᵢ and lᵢ) of Eqs. (10) and (14).

The present disclosure aims to predict the arrival time from 200 miles of the TMA, and the aircraft can adjust the speed in the en-route phase to reach the scheduled arrival time. The fuel consumption can be limited to a low level if the scheduled arrival time is constrained to a time window around the optimal speed. Thus, fuel consumption is also considered in the constraints. The fuel consumption constraints are incorporated into the calculation of upper bound uᵢ and lower bound lᵢ of the time window constraints, adjusted based on the distribution of tᵢⱼ.

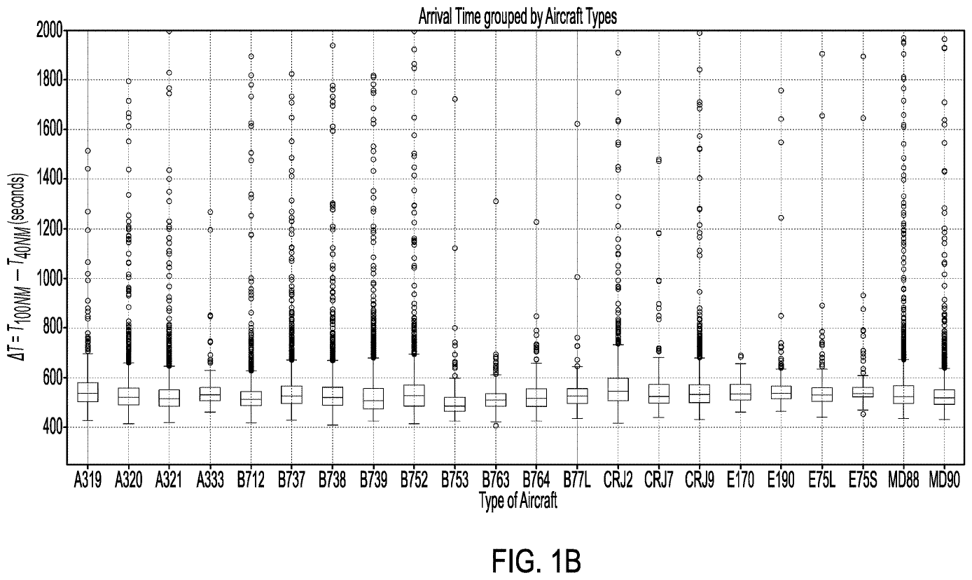

The complete ALS procedure is shown in FIG. 2. The aviation source data are obtained from the Sherlock Data Warehouse and processed into well-organized feature representations. The Boosting model takes the processed feature and fits into base learners sequentially, where the residuals are concatenated for the best set of base learners. The boosting model predicts the distribution of the landing time for each landing aircraft tᵢ, tⱼ, and tᵢⱼ is further derived as the constraint of TSP-TW for optimal landing sequencing. GBM is trained with real-world air traffic data, to predict the estimated aircraft landing time with associated uncertainty intervals. First, a look-ahead horizon is defined to determine the rolling time window for scheduling. For instance, the TMA ranges from 100 nautical miles to 200 nautical miles from the destination airport. The detected number of aircraft in this area is n. The maximum number of aircraft to be scheduled is constrained to nₘₐₓ to limit the computation complexity for real-time implementation. If n≥nₘₐₓ, the first nₘₐₓ aircrafts are selected and the system performs the landing scheduling, otherwise all the aircraft in the current horizon are selected for landing scheduling. The trained model is used to predict the arrival time of all the affected aircraft. Then the scheduled arrival time is calculated using the algorithm described above.

### Empirical Data Analysis

In this section, several flight delay scenarios were investigated via real-world aviation flight recordings. Through the investigations, it was discovered that the holding pattern is one of the major impact factors leading to flight delays. It was thus proposed to explicitly include safety-related flight event counts as the features for GBM to demonstrate effectiveness. A short description of the flight track and flight event data is given herein.

### Investigation on Flight Delays

FIGS. 3A and 3B show the relevant time spent from three different distance intervals ([200, 100], [100, 40], [40, 0] nautical miles) away from the terminal. The flight track data is obtained from Sherlock Data Warehouse (SDW) and is visualized. SDW is a distributed big data platform for data visualization to support air traffic management research. Sherlock includes a database, a web-based user interface, a few data visualization tools, and other services. The flight data is stored in the Integrated Flight Format (IFF). It includes all raw data plus the derived fields such as flight summary, track points, and flight plan. The flight summary is a general description of the flight which contains flight time, flight call sign, aircraft type, origin, and destination information. The flight track points are the record of real flight operations. It includes the ground-measured aircraft position in both the spatial and temporal aspects. The format of flight track data in SDW and conversion between WGS84 coordinates to absolute distance has been discussed in previous work.

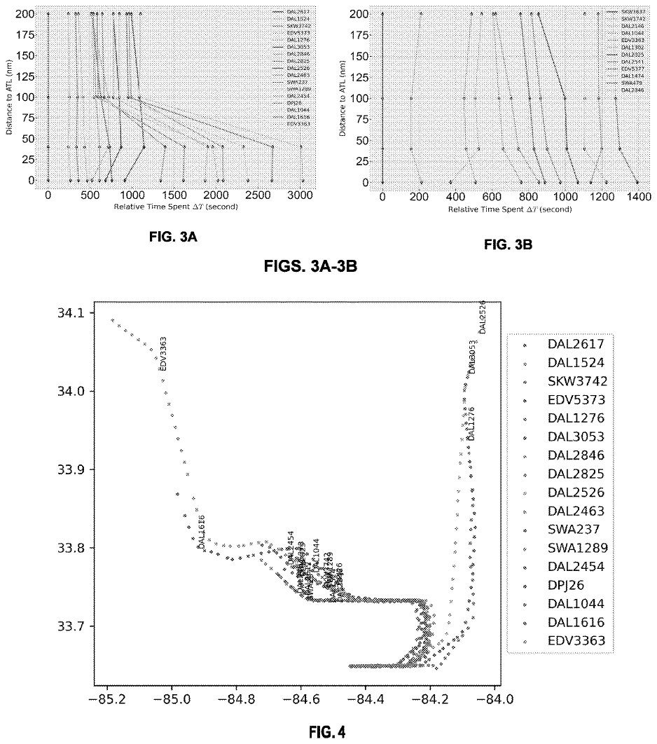

In FIG. 3A, the landing aircraft is visualized between the time window 13:20 and 13:45 on Monday, Aug. 1, 2019, during which severe landing flight delays happened. For reference, the normal flight landing process of the next consecutive Monday is also visualized in FIG. 3B. During the given time window, 17 flights entering the 100 nautical mile range from the terminal are captured by the surveillance radar. FIG. 3A shows flight delay starts at the 5^{th} flight. Flight tracks during this time window are shown in FIG. 4.

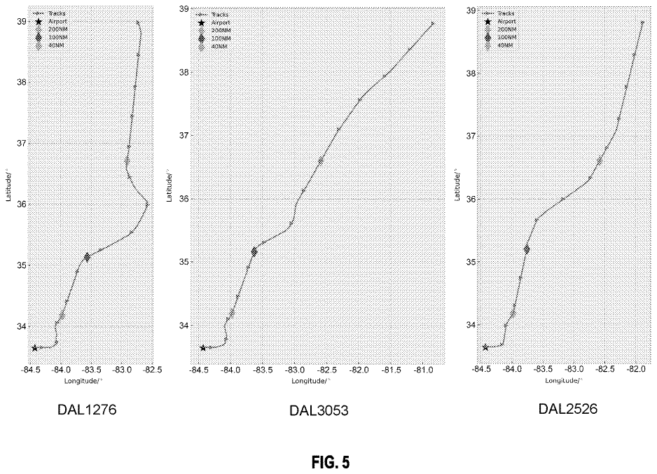

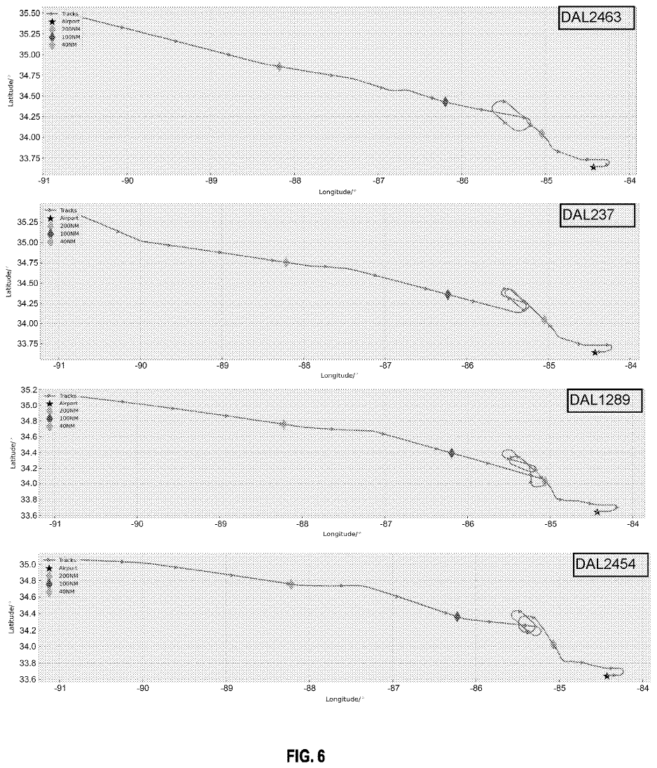

The complete tracks for 3 landing flights (DAL1276, DAL3053, DAL2526) coming from the northeast towards an east landing, and 7 landing flights coming from the northwest towards an east landing are drawn. In FIGS. 5 and 6, the diamond marks represent the location of reaching 200, 100, 40 NM from the airport center. Valuable insights are gained from FIGS. 5 and 6, (a) holding command is the common practice during ALS, and the flight receives a holding command loop around in the airspace; (b) holding pattern contributes to the long arrival time within the TMA, and can last for various period; (c) holding pattern usually happens when the aircraft is in TMA range [100, 40] NM, where FCFS rule takes effect for air traffic control.

It is obvious that holding in the congested near terminal airspace poses a safety concern to air traffic operations, which motivates the proposed method to perform from an extended TMA. In this work, it is proposed to do ALS from an extended TMA, such that an early landing scheduling can be issued. By doing this, the near terminal airspace complexity can be alleviated, and landing aircraft can adjust the speed profile to account for the issued arrival time over 100 NM away from the terminal.

### Aviation Data Mining

The aviation data used in this work are obtained from the SDW, where the flight tracks and flight event recordings are of interest, while the weather data are obtained from the open dataset.

### Flight Track Recordings

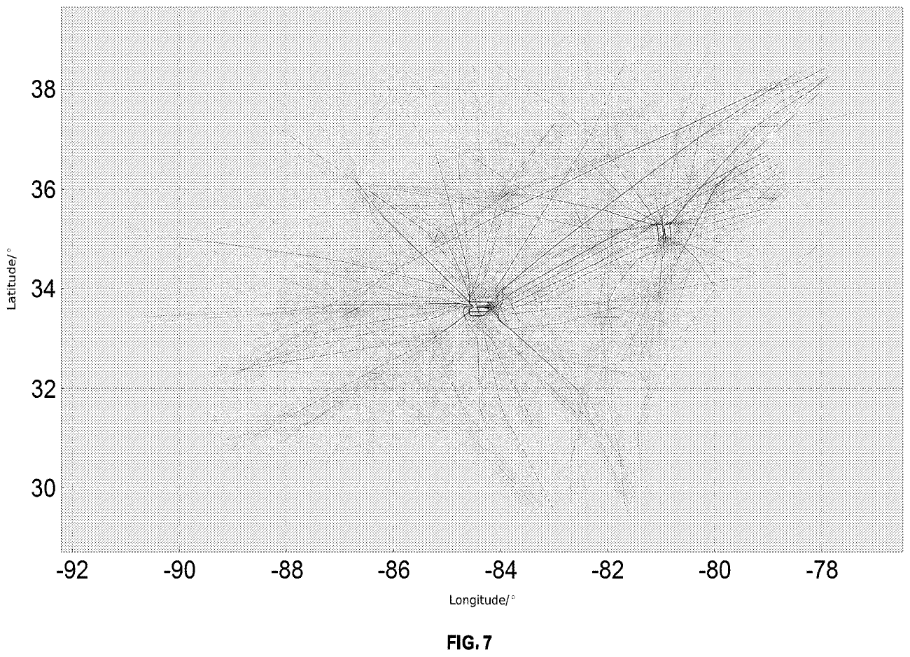

The flight track data takes the standard Integrated File Format (IFF) for aviation standards. The IFF flight track data contains the processed raw flight data collected from FAA facilities across the United States territories, as well as some derived features such as flight summary. IFF flight track data from the FAA Atlanta Air Route Traffic Control Center (ARTCC ZTL) is used herein. ARTCC ZTL covers airspace across Alabama, Georgia, South Carolina, Tennessee, and North Carolina. For a better illustration of ARTCC ATL, FIG. 7 shows the flight tracks recorded in ARTCC ZTL.

IFF flight track data contains the flight operational features (e.g., flight plans, flight callsign), positional features (e.g., coordinates, speed, course), and flight identifiers/codes (e.g., Beacon code, operations type). As discussed in previous sections, the present study is interested in the features that can represent the status of the target aircraft, as well as the nearby airspace complexity. A proper set of features are selected and constructed for the prediction of landing aircraft arrival times, as shown in Table 2. These features show an impact on the prediction performances. The aircraft type is obtained from the Sherlock data. Latitude, longitude, and altitude are used as the spatial features, each coordinate is associated with a timestamp. The timestamp is also rounded to full hours with the assumption that the hours of operation will impact the aircraft's landing time. Additionally, the number of aircraft ahead of the target aircraft are counted as the indicators for airspace complexity measure. The airspace complexity largely impacts the workload of the controller, which further leads to potential flight delays due to ATC.

TABLE 2
List of features used in probabilistic estimated arrival time prediction model.

| Feature group | Feature name | Description |
|---|---|---|
| Flight | acType | Type of the aircraft |
| Conditions | Latitude | Latitude |
| | Longitude | Longitude |
| | Altitude | Altitude |
| | Distance | Distance to the destination |
| | Time | Timestamp |
| | Hour | Round to the nearest full hour |
| | GroundSpeed | Aircraft ground speed |
| Airspace | AC_10 (30, 60) mins_ahead | Aircraft count 10 (30, 60) min ahead |
| Complexities | AC_10 (30, 60) mins_behind | Aircraft count 10 (30, 60) min behind |
| | EV_RRT_10 (30, 60) | Reroute event count 10 (30, 60) min ahead |
| | EV_LOOP_10 (30, 60) | Looping event count 10 (30, 60) min ahead |
| | EV_GOA_10 (30, 60) | Go around event count 10 (30, 60) min ahead |
| Weather | windspeed | Wind speed |
| Conditions | winddir | Wind direction from the true north |
| | cloudcover | Height of the cloud cover |
| | visibility | Visibility level |
| | humidity | Humidity percentage |

### Flight Event Recordings

Flight event recordings are also processed and archived in SDW. IFF flight event data are well-organized tabular format data, instead of time-series coordinates combined with tabular information in flight track data. The timestamp, location, and flight callsign associated with the flight event are stored. Table 3 shows the detailed descriptions of fifteen different flight event types recorded in the data. Three safety-related flight events are identified. Similarly, the feature is processed based on the timestamp that the target landing aircraft reaches the defined TMA, which has the same levels (e.g., 10 min, 30 min, 60 min). The number of flight events that happened ahead or behind the target aircraft for each level are counted. In such a way, the flight event recordings are obtained as the predicted safety indicators for the target aircraft. Table 2 lists the name of the flight events processed.

### Weather Features

Weather impact is a critical factor of aviation safety and is thus non-negligible in aviation operations. This work also explores performance improvement in machine learning with explicit weather feature inputs. The wind speed, wind direction, cloud cover, visibility, and humidity near KATL are obtained. The hourly weather features are used to record and refer to the full-hour flight monitoring records in Table 2 to build the final feature table for ML prediction.

### Case Study on Scheduling

In this section, machine learning prediction and flight delay optimization case studies are introduced. First, the performance evaluation metrics are briefly discussed. Then the condition-based machine learning predictor for improved performance is explained, where the processed features are classified based on the number of looping event counts. Last, it is shown that the proposed machine learning-enhanced TSP-TW solution can achieve a shorter total landing time compared to FCFS, for all of the landing aircraft within a time window.

### Performance Evaluation Metrics

Proper performance evaluation metrics are required to select the best parameter setup for the machine learning model. Considering a supervised regression problem, three cost functions are proposed to address various statistical behaviors. Define a predicted label γᵢ and the ground truth [symbol] , to obtain,

Mean Absolute Error (MAE): MAE is the arithmetic average of the absolute errors between predicted labels and ground truth labels. MAE is a commonly used metric in forecasting and prediction objectives. MAE weighs each sample at the same scale.

$$MAE = \frac{1}{n} {\sum }_{i = 0}^{n} \vert {y}_{i} - {\hat{y}}_{i} \vert \qquad ( 20 )$$

TABLE 3
List of flight event types in IFF flight event data. The three safety-
related flight events are EV_RRT, EV_LOOP, and EV-GOA.

| Event type | Descriptions |
|---|---|
| EV_TOF | Take off event; defined when the aircraft crosses |
| | the departure runway threshold/aircraft wheels |
| | come off the pavement. |
| EV_USER | User event; a flexible event defined by users |
| | preference (e.g., how many times an airplane |
| | goes into a center, different volume definitions). |
| EV_MOF | Mode of flight; a measure of aircraft trajectory |
| | in the vertical domain (e.g., descending level, |
| | climbing level). |
| EV_INIT | Indicator of flight track beginning recorded by |
| | the facility surveillance system. |
| EV_TRNS | Transition from above/below altitude. Not often |
| | used. |
| EV_XING | Crossing event; defined when aircraft is |
| | crossing between different spaces. |
| EV_RRT | Reroute event; defined when there is a new flight |
| | plan issued. Issuing reroutes significantly |
| | increases the workload of the ATC, which poses |
| | safety concerns. |
| EV_TOC | Top of climb; defined when the aircraft reaches |
| | the cruise altitude. |
| EV_TOD | Top of descend; defined when the aircraft starts |
| | to descend from the cruise altitude. |
| EV_PXCP | Unknown event type. |
| EV_LND | Landing event; defined when the arrival aircraft |
| | passes the arrival runway threshold. |
| EV_LOOP | Holding event; defined when the aircraft is |
| | circling around in the trajectory. Looping in |
| | the TMA increases airspace complexity and leads |
| | to safety concerns. |
| EV_STOL | Holding end; defined when the LOOP event ended. |
| EV_STOP | Indicator of stopping flight track recording by |
| | the surveillance systems. |
| EV_GOA | Go around event; defined when the aircraft aborted |
| | landing in final approach or after touchdown. Go |
| | around is a major safety concern. |

TABLE 4
GBM Hyperparameters and search space for grid search.

| Parameters | Definition | Search space |
|---|---|---|
| learn_rate | The learning rate for the optimizer. | [0.05, 0.1] |
| max_depth | The maximum tree depth. | [7, 8, 9, 10, |
| | | 11, 12] |
| sample_rate | The sample without replacement | [0.8, 1.0] |
| | rate along the feature dimension. | |
| col_sample_rate | The sample without replacement | [0.5, 0.6, 0.7, |
| | rate along the sample dimension. | 0.8] |

Root Mean Squared Error (RMSE): RMSE is an alternative to MAE, which share the same drawbacks. RMSE is sensitive to outliers, where a significantly bad prediction aggravates the overall performance measure. This skews the evaluation results towards overestimating the models' badness.

$$RMSE = \sqrt{\frac{1}{n} {\sum }_{i = 0}^{n} {( {y}_{i} - {\hat{y}}_{i} )}^{2}} \qquad ( 21 )$$

Root Mean Squared Log Error (RMSLE): In ALS predictions, severe delays can happen due to various reasons, which are treated as outliers in data-driven prediction. These outliers are unlikely to be captured by predictors and result in overestimating of model's badness. This can be misleading. It is proposed to use RMSLE, as shown in Eq. (22). RMSLE is viewed as the RMSE of log-transformed prediction and log-transformed ground truth. RMSLE is preferred as over-penalizing severe delay scenarios must be avoided, which helps select the best model parameters.

$$RMSLE = \sqrt{\frac{1}{n} {\sum }_{i = 0}^{n} {[ log ( {y}_{i} + 1 ) - log ( {\hat{y}}_{i} + 1 ) ]}^{2}} \qquad ( 22 )$$

### Prediction Analysis

The model development/training phase has two objectives, predicting the ETA distributions with GBM and formulating the predicted values into optimization for the demonstration of case studies. The first part requires model-tuning efforts. This is tackled from three aspects,

Grid Search is common practice to fine-tune parameterized machine learning predictors, to find the best combination of modifiable hyperparameters. For the GBM used in this work, there is particular interest in the following hyperparameters, (a) the learning rate controlling the step size of optimization (efficiency); (b) the maximum tree depth to control the order of approximations (accuracy); (c) the data sampling rate along the feature and sample dimension (stochasticity). Discussion of (b) and (c) are presented previously. The search space of this study is listed in Table 4.

Domain Knowledge and human intelligence can benefit data-driven models. As previously discussed, the impact of holding patterns on flight delays have been discovered. The holding pattern is recorded as a looping event in the IFF flight event recordings. Airspace complexity is represented by the number of nearby aircraft of the target landing aircraft. As discussed previously, the airspace complexity measurements and flight event number that happened within the certain time range of the target landing aircraft are implicitly included. Lastly, weather features are critical for aviation operations and thus are non-negligible when building ML predictors.

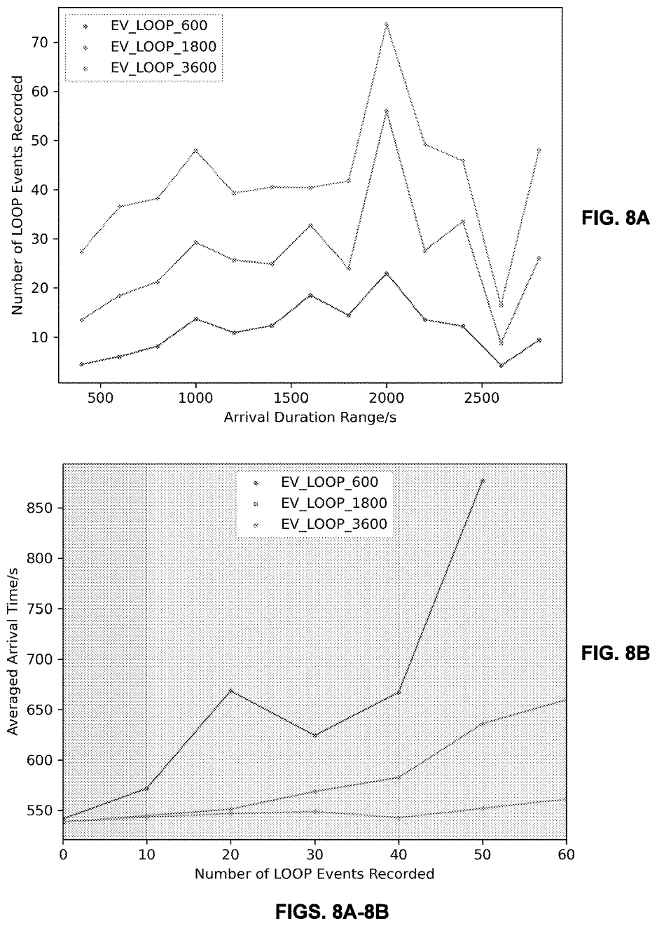

Divide-and-Conquer stands for gaining and maintaining outstanding ML performance divisively. The present disclosure proposes conditional GBM, which pre-filters the data samples based on the number of looping event counts, to gain exceptional prediction capability. FIGS. 8A and 8B shows the statistical analysis between the number of flight events and the arrival aircraft landing time within the [100, 40] NM range. FIG. 8A shows a non-monotonic trend, where an obvious drop of looping events is presented when the arrival time is greater than 2500 s. However, from FIG. 8B, it can be noticed that there are approximately three stages along with the increase of looping event counts. Separating the entire dataset into three parts and trained with separate GBM models, each of the separations are discussed as,
Stage I (EV_LOOP≤10): In this stage, minimum flight event conditions exist, where the arrival time duration is near optimal. At this stage, the arrival time increase is not significant.
Stage II (10<EV_LOOP≤40): The steady growth stage. At this stage, the arrival time duration is steadily growing with the increase of looping event counts.
Stage III (EV_LOOP>40): The rapidly increasing stage. The arrival time sharply increases when the number of looping events increases.

The flight track and flight event data for August 2019 at ARTCC ZTL are collected and processed. A total of 28,181 well-structured arrival flight information is obtained, with the feature set described in previous sections. Then, the data is filtered for three stages based on the EV_LOOP_600 feature. For each stage, the data is further separated into training, validations, and testing set. The training and validation sets are used for GBM training and fine-tuning, and the testing set is used for prediction case studies.

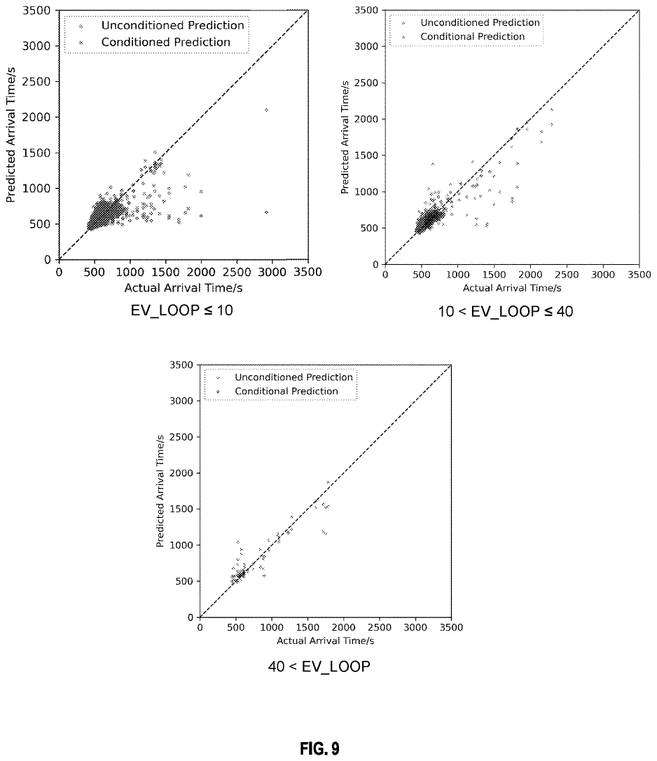

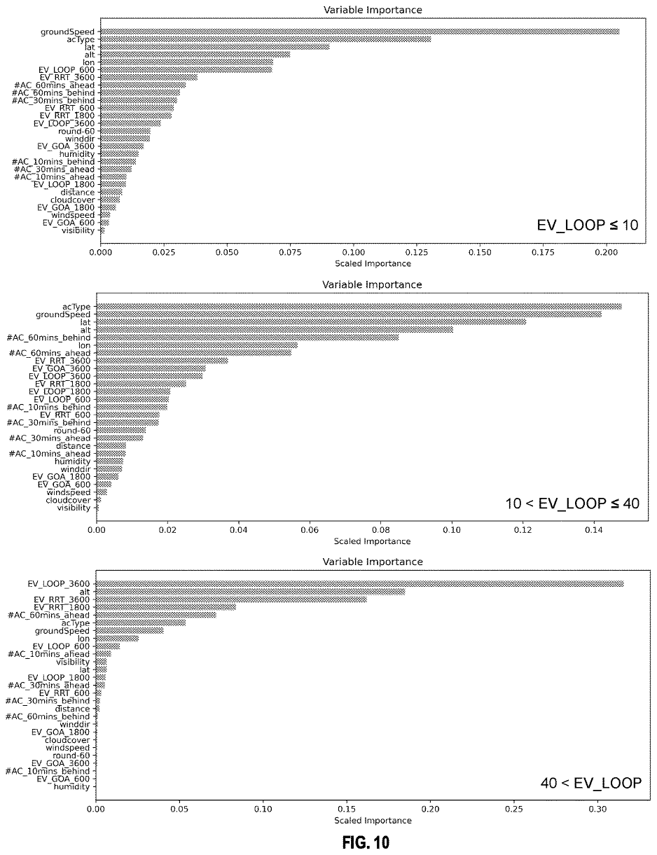

In Table 5, the performance of the three-stage model using the testing dataset is evaluated and compared with the unconditional method without considering different growth behaviors. Including the flight event-related features and weather features boost the model performance by a large margin, while the conditioned predictor further refines the results. FIG. 9 shows the evaluation results in comparison for unconditioned predictions and conditioned predictions. FIG. 10 shows the corresponding variable (feature) importance for conditioned predictors. For stage I, the conditioned prediction does not significantly improve the prediction accuracy. At this stage, the number of looping events is not a critical variable for the GBM. The ground speed is prominently dominant in the stage I predictions. However, for stage II and stage III, the conditioned predictor greatly enhanced the performance. At stage II, the type of aircraft shows nearly the same variable importance as the ground speed. Notably, at stage III, the ground speed turns into a less critical factor contributing to the overall model performance. The airspace complexity factors, geological information, weather features, and flight safety-related events are essential.

### ALS Case Studies

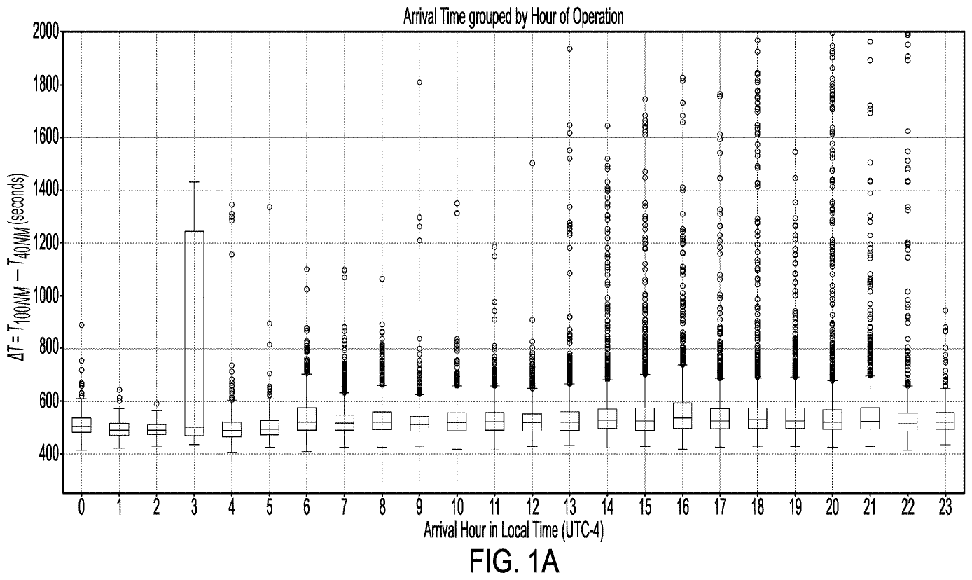

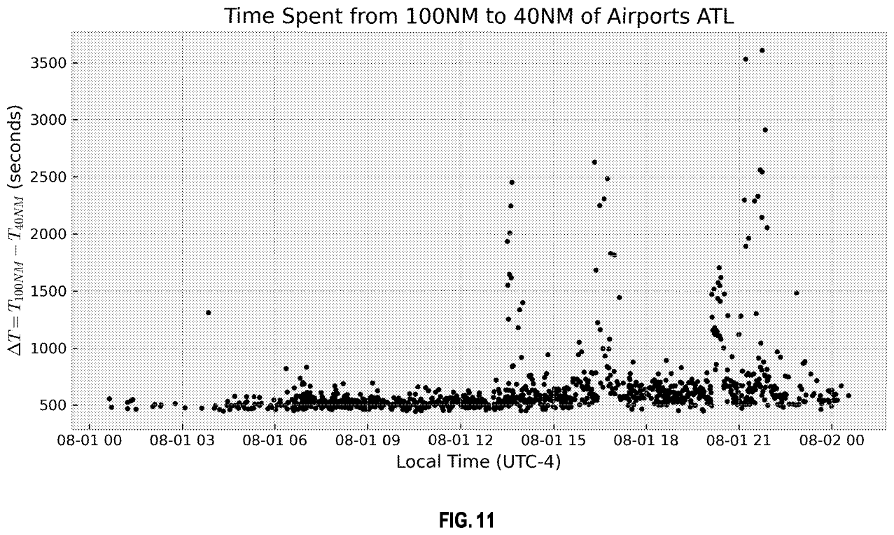

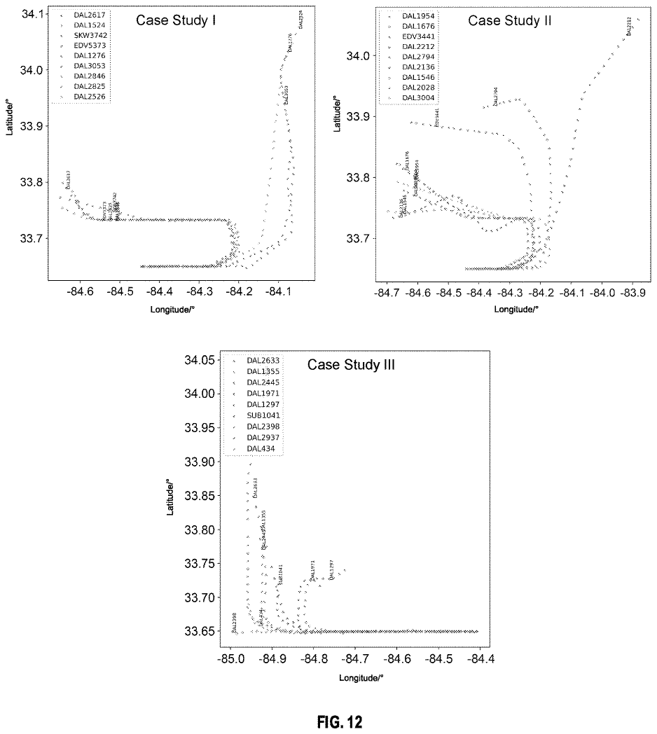

This section discusses real-world demonstration case studies. At first, the problem horizon is defined by visualizing and analyzing the real-world data. FIG. 11 shows the scatter plot of time spent for approaching flights around KATL TML on Aug. 1, 2019. The increased scatter density indicates the business of aviation operations at a certain timestamp. The Y-axis denotes the flight time from 100 NM to 40 NM away from the terminal TMA. It is clear that the normal time spent should be lower than 1000 seconds, which are also cross-referenced by FIGS. 1A and 3B. Based on these, it can be concluded that there are three severely delayed time ranges, starting from 13:00, 16:00, and 21:00, approximately. In this demonstration, three case studies are presented. In the first scenario, 9 successive landing flights from 13:20 to 13:45 are taken and the trajectories are shown in FIG. 12A. These landing flights mostly follow two groups of landing procedures. The first group of 6 flights came from the west side of KATL for a west landing on KATL runway 26R, while another group of landing aircraft came from the northeast for the same west landing at 26R. Similarly, in the second case study, the time duration is set starting from 16:00 to 16:30. Case II has three groups of landing procedures, where flight EDV3441 and DAL2794 maneuvered for west landing ahead of time. Case III considers all west landing scenarios within the 200 NM TMA. The selection of time windows is based on the availability of aircraft landing on the same runway, and the scalability of the TSP-TW solver.

From GBM, the distributions for successive landing aircraft pair tᵢ~ [symbol] (μᵢ,σᵢ), tⱼ~ [symbol] (μⱼ,σⱼ) are obtained. To determine the [symbol] for various aircraft types, FAA Order JO 7360.1H (FAA, 2023 Mar. 27) is referred to. Following Eq. (18), the distribution of tᵢⱼ is obtained. Given the separation violation probability, the probability intervals with numerical tools can be estimated. In this way, [symbol] ᵢⱼ,uᵢ, and ii are obtained from the learning of historical data. Then, the learned parameters are incorporated into the formulation of TSP-TW and solved with Python optimization solvers. It is worth pointing out that, the aircraft involved in the present case studies are classified as medium size aircraft. Based on Table 1, the Large-Large minimum separation threshold, 64 seconds, were chosen for the case studies. The number of landing aircraft was set to 9 for both cases due to the computational complexity, which corresponds to at least ~10 min optimization horizon in extreme scenarios. The exploration of other efficient solvers for MILP is beyond the focus of this study.

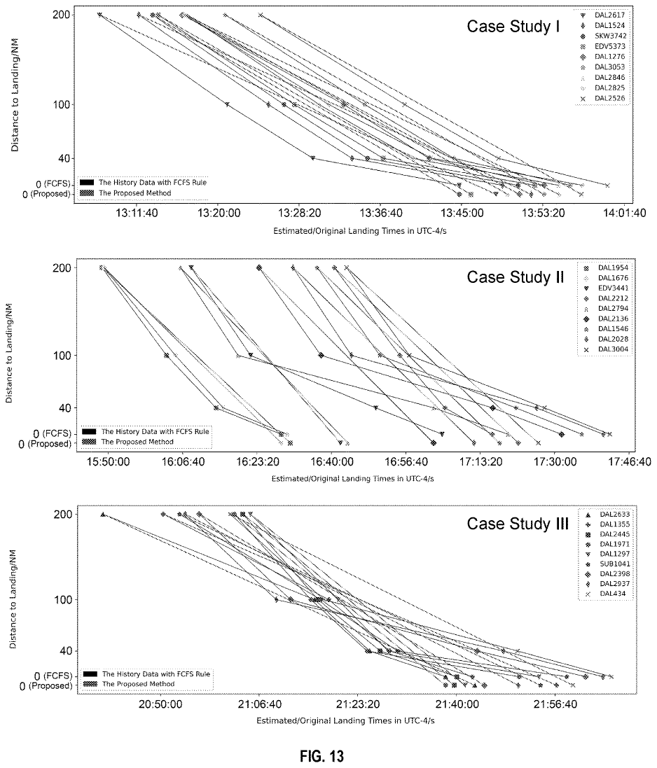

The detailed landing scheduling results are listed in Table 6 and FIG. 13. Table 6 gives the original sequence of landing aircraft entering the 100 NM TMA, and their predicted corresponding landing sequence, and estimated landing time from the proposed method. The MSTs between two successive landing aircraft comply with FAA regulations while incorporating additional uncertainties learned from aviation history recordings. FIG. 13 compares the total landing time between the FCFS rule (history recordings) and the proposed methods. As mentioned above, the straightforward objective is to achieve a shorter total landing time for all the landing aircraft heading the same runway. FIG. 13 colors the optimized landing time in red, and the total landing time for all the aircraft is the landing time difference between the first landed aircraft and the last landed aircraft (i.e., in case I, the time duration between 13:44:47 for SKW3742 and 13:57:17 for DAL2526 is 12 min and 30 s). The average landing time reduction reaches 17.2% across three case studies. The reasons for improved performance are two folds, (a) The proposed method takes advantage of the prediction power of machine learning tools by estimating the landing time distributions for each landing aircraft from historical patterns, based on several related factors (number of flight events ahead, aircraft performance factors like speed). The predicted landing time further calculates the minimum separation time of the leading aircraft, which calibrates the sub-optimal landing buffer time using the reliability concept developed in Balakrishnan and Chandran (2010); (b) By incorporating the calibrated minimum separation time into the Optimization constraints, and time-constrained traveling salesman problem, the proposed method is able to find the optimal landing sequence that minimizes the total time required while satisfying the landing time interval for each aircraft. It was noticed that in the case studies, the number of shifts for the landing aircraft is up to 6, where a higher shifts number leads to a shorter total landing time.

In some aspects, the proposed method and system may include automatically increasing or decreasing a speed of an approaching aircraft according to the determined aircraft landing schedule. In further aspects, the proposed method and system may include instructing a pilot of an approaching aircraft to increase or decrease the speed of the aircraft in order to meet the determined aircraft landing schedule.

Additionally, the proposed method requires the speed up in velocity profiles for several aircraft to meet the landing sequence, which leads to the discussion on aviation sustainability.

Although aircraft emissions only account for a small percentage of total CO₂ emissions globally, they have a more significant impact on climate change due to their high-altitude release, and the associated contrails can amplify its warming potential.

Innovations towards aviation sustainability come from three folds, (a) Aircraft technology advancement involves using lightweight materials, advanced aerodynamics, and alternative propulsion technologies like electric and hybrid-electric systems (e.g., GE Hybrid Engine). (b) alternative fuels include recycled fuels, blended fuels, or even zero-emission hydrogen fuels (e.g., sustainable fuels). (c) improve ATM efficiency with operational optimization can lead to more direct fuel consumption reduction. Following (c), various research works are proposed to include fuel consumption factors in the aircraft landing scheduling process.

TABLE 6
The detailed ALS results for three case studies. The determination
of the case study windows has been discussed. Depending on FAA
Order JO 7360.1H (FAA, 2023 Mar. 27), all of the aircraft involved
in these case studies belong to the medium-weight class. Referring
to Table 1, the Large-Large [symbol] is used to be fixed at
64. All of the Unix timestamps contained in the data have been
transformed to the local time zone at ARTCC ZTL (UTC-4).

| | | | | | | |
|---|---|---|---|---|---|---|
| Entering | | | | Landing | Landing | |
| Sequence | Callsign | AcType | [symbol] /s | Sequence | Time | σᵢⱼ/s |

Case Study I: 13:20-13:45

| | | | | | | |
|---|---|---|---|---|---|---|
| 1 | DAL2617 | B712 | 64 | 3 | 13:48:32 | 4.52 |
| 2 | DAL1524 | B752 | 64 | 4 | 13:49:45 | 6.35 |
| 3 | SKW3742 | CRJ2 | 64 | 1 | 13:44:47 | 5.15 |
| 4 | EDV5373 | CRJ7 | 64 | 7 | 13:53:28 | 0.15 |
| 5 | DAL1276 | MD88 | 64 | 5 | 13:50:56 | 3.00 |
| 6 | DAL3053 | MD88 | 64 | 2 | 13:45:58 | 2.52 |
| 7 | DAL2846 | MD88 | 64 | 6 | 13:52:09 | 5.30 |
| 8 | DAL2825 | B738 | 64 | 8 | 13:54:59 | 21.24 |
| 9 | DAL2526 | MD88 | 64 | 9 | 13:57:17 | 8.17 |

Case Study II: 16:00-16:30

| | | | | | | |
|---|---|---|---|---|---|---|
| 1 | DAL1954 | A321 | 64 | 2 | 16:30:46 | 26.42 |
| 2 | DAL1676 | MD88 | 64 | 1 | 16:28:45 | 35.36 |
| 3 | EDV3441 | CRJ9 | 64 | 3 | 16:41:59 | 4.88 |
| 4 | DAL2212 | B712 | 64 | 5 | 17:02:53 | 16.63 |
| 5 | DAL2794 | B739 | 64 | 6 | 17:11:57 | 27.68 |
| 6 | DAL2136 | MD90 | 64 | 8 | 17:21:53 | 104.62 |
| 7 | DAL1546 | A321 | 64 | 7 | 17:17:42 | 145.11 |
| 8 | DAL2028 | A321 | 64 | 4 | 16:43:40 | 163.95 |
| 9 | DAL3004 | B739 | 64 | 9 | 17:26:21 | 158.20 |

Case Study III: 21:00-21:20

| | | | | | | |
|---|---|---|---|---|---|---|
| 1 | DAL2633 | B739 | 64 | 4 | 21:43:07 | 25.72 |
| 2 | DAL1355 | B739 | 64 | 3 | 21:41:29 | 76.47 |
| 3 | DAL2445 | B712 | 64 | 5 | 21:44:45 | 2.03 |
| 4 | DAL1971 | MD88 | 64 | 1 | 21:38:12 | 18.37 |
| 5 | DAL1297 | MD88 | 64 | 7 | 21:54:14 | 7.54 |
| 6 | SUB1041 | B190 | 64 | 8 | 21:56:57 | 9.69 |
| 7 | DAL2398 | B712 | 64 | 6 | 21:50:28 | 5.69 |
| 8 | DAL2937 | A321 | 64 | 2 | 21:39:54 | 125.96 |
| 9 | DAL434 | MD90 | 64 | 9 | 21:59:42 | 19.57 |

Neuman and Erzberger (1991) discover that if an aircraft is allowed to speed up in TMA, and land before the earliest landing time, there will potentially be significant landing time reductions to the following aircraft. However, this obviously leads to additional fuel consumption. Lee (2008) investigated the tradeoff between landing scheduling algorithms and fuel consumption. Specifically, the tradeoff between speedup (time advance) and fuel consumption is investigated. Based on their aircraft landing cost model, they discover that (i) the optimization shows that allowing up to 3 min of time advance is optimal in most tested cases. Beyond 3 min, the extra fuel burn negates the savings from the reduced delay; (ii) the benefits of time advance in reducing fuel costs diminish as the number of precedence constraints (e.g. from overtaking restrictions) increases. A heavily constrained sequence leaves little flexibility to take advantage of time advance; (iii) while reducing average delay generally reduces fuel costs, the minimum fuel cost solution sometimes has higher delays than the minimum delay solution; (iv) there is no single optimal tradeoff—the balance depends on operational constraints, aircraft types, and fuel/delay costs. Overall, they provide an approach to investigate the best tradeoff given specific conditions. In recent years, there are some efforts on co-optimizing the delays and fuel costs. The E-constraint method is shown to reduce up to 4.5% total fuel consumption in a real-world case study in Madrid, Spain. However, they notice the increased computation complexity and that heavy congestion reduces opportunities for improvement, which can be the intended usage of such models.

### CONCLUSIONS

The present disclosure proposes a novel machine learning-enhanced aircraft landing scheduling algorithm, which provides a new conceptual design to avoid significant delays with safety constraints. First, the aircraft landing scheduling algorithm is formulated into a time-constrained traveling salesman problem. Being machine learning-enhanced, machine learning-predicted results are incorporated into several safety-related constraints of the time-constrained traveling salesman problem formulation. Regarding the machine learning prediction algorithm, it is proposed to explicitly introduce nearby flight event situations and airspace complexity measurements into the conditional data-driven learner, which greatly enhances the prediction accuracy. The variable importance analysis suggests that aircraft type, ground speed, distance to destination, and airspace density are key factors affecting arrival time prediction accuracy. Finally, the performance of the proposed method is evaluated and compared through real-world case studies during peak hours at ARTCC ZTL. Various uncertainties from aircraft, speed, and airspace density are included. The key concept is to optimize the scheduling using enhanced operational predictability combining advanced instruments (e.g., ADS-B) and data analysis (e.g., arrival time prediction model in this study).

Insights: A few insights are discussed based on the current investigation, and a few potential research directions are suggested.
The scalability of this work can be improved. In extreme cases, the current optimization horizon corresponds to a planning horizon of ~10 min. Dynamic scheduling with rolling window horizons can be integrated with the current method to extend the proposed method for a longer planning horizon. The performance of this extension can also be evaluated.
The proposed study focuses on the methodology demonstration and only uses limited data at one ARTCC. A significant amount of data collection and validation at multiple airports is suggested. Model adaptiveness and generalization enhancements to multiple airports can be helpful.
Weather is an important factor affecting arrival time prediction. The proposed model only considers weather on the hourly level. In future investigations, a finer-grided weather feature dataset shall be selected to validate the weather inclusion impact.
Aircraft performance variables (i.e., fuel consumptions) are another group of critical factors to flight operations, as it directly impacts operating costs and environmental sustainability. It is suggested to include aircraft performance measures in the optimization formulation such that fuel efficiency can be directly addressed.
Another important research direction is multi-runway aircraft landing scheduling, which can be especially important for ATC of major international airports. The multi-runway scheduling problem is more challenging, and significant further study is needed. Both hierarchical and concurrent optimization can be used based on present beliefs. Performance evaluation and scalability need to be balanced for decision support.

### Computer-Implemented System

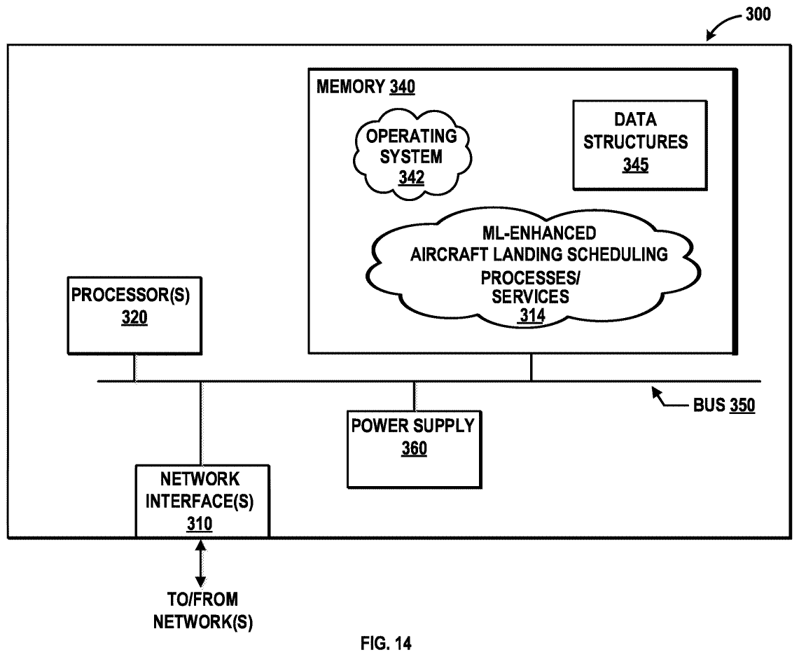

FIG. 14 is a schematic block diagram of an example device 300 that may be used with one or more embodiments described herein, e.g., as a component of system 100.

Device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.).

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360.

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches).

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include ML enhanced aircraft landing scheduling processes/services 314 described herein. Note that while ML enhanced aircraft landing scheduling processes/services 314 is illustrated in centralized memory 340, alternative embodiments provide for the process to be operated within the network interfaces 310, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the ML enhanced aircraft landing scheduling processes/services 314 is shown as a standalone process, those skilled in the art will appreciate that this process may be executed as a routine or module within other processes.

What is claimed is:

1. A system for determining an optimal aircraft landing schedule, comprising:
a memory; and
a processor having access to a set of executable instructions located on the memory which, when executed, cause the processor to:
retrieve, from the memory, historical flight data;
process, using the processor, the historical flight data into feature representations;
sequentially fit, using the processor, the processed feature representations into base learners using a machine learning model;
training the machine learning model to predict landing times for any successive approaching aircraft pair of a plurality of approaching aircraft using the base learners for an airport;
predict, using the trained machine learning model, a distribution of landing times for the successive approaching aircraft pair, wherein the prediction incorporates uncertainties between successive flights within the historical flight data; and
determine, using a traveling salesman problem formulation with time window constraints, an aircraft landing schedule for the plurality of approaching aircraft for the airport based on the distribution of predicted landing times.

2. The system of claim 1, wherein the machine learning model determines a minimum separation time for the successive approaching aircraft pair.

3. The system of claim 1, wherein the historical flight data includes nearby flight event situations and airspace complexity measurements.

4. The system of claim 1, wherein the machine learning model is a gradient boosted machine with weighted quantiles.

5. The system of claim 1, wherein the traveling salesman problem is further constrained by a minimum aircraft separation time and fuel consumption.

6. The system of claim 1, wherein the plurality of approaching aircraft includes all approaching aircraft within a range of about 100 to about 200 nautical miles from the airport.

7. The system of claim 1, wherein the processor determines the aircraft landing schedule for one runway of the airport.

8. The system of claim 1, wherein the processor determines the aircraft landing schedule for two or more runways of the airport.

9. The system of claim 1, wherein the processor has access to further instructions which, when executed, cause the processor to increase or decrease a speed of an approaching aircraft of the plurality of approaching aircraft.

10. The system of claim 1, wherein the aircraft landing schedule is determined by minimizing a total time required for approaching for the plurality of approaching aircraft while satisfying the predicted landing times.

11. A method for aircraft landing schedule optimization, comprising:
receiving, at a processor, aviation data for a plurality of approaching aircraft;
predicting, using a machine learning model, a landing time and an uncertainty interval for each approaching aircraft of the plurality of approaching aircraft, wherein the machine learning model is trained on historical flight data;
determining, using the machine learning model, a minimum separation time for any successive pair of approaching aircraft of the plurality of approaching aircraft based on the predicted landing time and uncertainty interval;
determining, using a traveling salesman problem with time window constraints, an aircraft landing schedule for the plurality of approaching aircraft for an airport, wherein the time window constraints include the minimum separation time, predicted landing time, and uncertainty interval.

12. The method of claim 11, wherein the historical flight data is filtered to include historical flight data for flights where the time spent within about 100 NM to about 40 NM of the airport by an aircraft corresponds to a historical average time spent within about 100 NM to about 40 NM of the airport where at least 40 loop events have occurred.

13. The method of claim 11, wherein the machine learning model is a gradient boosted machine with weighted quantiles.

14. The method of claim 11, wherein the machine learning model predicts the landing time and uncertainty interval taking into account uncertainties between successive flights within the historical flight data.

15. The method of claim 11, wherein the plurality of approaching flights includes all approaching aircraft within a rolling time window to be scheduled.

16. The method of claim 11, wherein the plurality of approaching flights includes all approaching aircraft within 100 NM to about 200 NM of the airport.

17. The method of claim 11, wherein the travelling salesman problem is further constrained by fuel consumption.

18. The method of claim 11, further comprising:
instructing, by the processor, an approaching aircraft to increase or decrease its speed according to the determined aircraft landing schedule.

19. The method of claim 11, further comprising:
increasing or decreasing a speed of an approaching aircraft of the plurality of approaching aircraft according to the determined aircraft landing schedule.

20. The method of claim 11, wherein the aircraft landing schedule is determined by minimizing a total time required for approaching for the plurality of approaching aircraft while satisfying the predicted landing time.
